(19) United States
(12) Patent Application Publication
(10) Pub. No.: US 2011/0206517 A1
(43) Pub. Date: Aug. 25, 2011

(54) TRANSMISSION DEVICE FOR A MACHINE FOR PRODUCING ELECTRICITY FROM A VARIABLE SPEED MOTIVE POWER SOURCE, UNIT FOR PRODUCING ELECTRICITY AND WIND TURBINE BOTH SO EQUIPPED, AND METHOD OF SETTING A TRANSMISSION RATIO

(75) Inventors: Roumen Antonov, Paris (FR); Bernard Pontet, Saint Cyr La Riviere (FR); Carl M. De Vries, Nieuwegein (NL)

(73) Assignee: S4 ENERGY B.V., Rotterdam (NL)

(21) Appl. No.: 12/866,927

(22) PCT Filed: Feb. 11, 2009
(86) PCT No.: PCT/FR2009/050218

§ 371 Date: Apr. 26, 2011

(30) Foreign Application Priority Data
Feb. 11, 2008 (FR) 0850849

(51) Int. Cl. F03D 11/02; F16H 48/06; F16H 61/00

(52) U.S. Cl. 416/170 R; 475/150; 74/473.1

(57) ABSTRACT

Two identical differential mechanisms are mounted in parallel between the input shaft connected to the rotor 1 of the wind generator by a speed step-up device, and the output shaft connected to a synchronous generator. The two planet gears are secured to the output shaft. The two planet carriers are secured to the input shaft. The two annulus gears therefore rotate at the same speed. They are connected by slightly differing transmission ratios, of which one is also reversing with respect to the other, to the two input elements of a comparator differential. The cage of this differential rotates at a speed equal to half the difference between the absolute values of the rotational speeds of the elements. After multiplication by gearing, this low speed is applied to the rotor of a regulating apparatus such as an electric generator. The transmission ratio is adjusted or regulated by altering the torque applied by the regulating generator. Use for perfectly stabilizing the rotational speed of the synchronous generator and allowing it to be constantly connected to the network with the regulating apparatus consuming only a small amount of energy.

### CROSS-REFERENCE TO RELATED APPLICATION

This application is the National Stage of International Application no. PCT/FR2009/050218 filed Feb. 11, 2009, which claims the benefit of French patent application number 0850849 filed Feb. 11, 2008, the contents of which are incorporated by reference as if fully set forth herein.

### FIELD OF THE INVENTION

The present invention relates to the field of wind turbines or any other field in which an electric generator has to be connected to a variable-speed motive power source.

The invention relates more specifically to a transmission device for a machine for producing electricity from a variable-speed rotary motive power source, particularly a wind turbine rotor.

The invention also relates to a unit for producing electricity that can be driven by a wind turbine rotor.

The invention further relates to a wind turbine equipped with the transmission device or with the unit for producing electricity.

The invention also relates to a method of setting a transmission ratio.

### BACKGROUND

At present, the use of wind turbines is still limited because the costs of producing and operating them is still very high in comparison with their efficiency. It is therefore of key importance to bring down the cost per kilowatt produced by the wind turbines. This is even a prerequisite for a boom in high-powered wind turbines able to produce as many as several megawatts.

One of the major difficulties is that of producing a current that is stable in terms of frequency in spite of the very wide variations in the speed at which the wind turbine rotor rotates, these variations being related to the variations, likewise very great, in wind speed. Usually, efforts are made to run the wind turbines when the wind speed falls between a minimum speed close to zero and a maximum speed of the order of 15 m per second. The rotational speed of the wind turbine rotor then typically varies between 1 and 30 revolutions per minute.

There are various proposals that have been made in an attempt to address this problem. First of all, the vast majority of wind turbines installed have an asynchronous generator, able to tolerate small variations in the speed of the generator input shaft. In order to increase suitability to wider ranges of speeds, some manufacturers fit their wind turbines with two generators, a small one for periods of weak wind and a larger one for periods of strong wind.

Wind turbines are also known that are provided with a generator with a variable number of poles. By altering the way in which the poles are connected, such a generator can operate on different numbers of poles, and therefore accommodate different rotational speeds.

In all cases, the frequency of the electrical current produced varies as a function of the rotational speed of the generator, which makes it impossible to connect to the grid or requires complex transformation in order to obtain a frequency that is compatible with that of the grid. In particular, a two-generator technology entails switching from one generator to the other in the supply to the electrical grid, and therefore the need regularly to adapt the frequency and phase of the current produced to suit those of the grid. This problem increases the price of the installation and does not significantly improve the efficiency of the wind turbine.

Also known, from document WO 2004/088132 A1, is a transmission device for a wind turbine generator. This device uses a main route for transmitting speed between the wind turbine rotor and the rotor of the generator, and a parallel regulating route in which there is a hydraulic torque converter. However, the stabilizing of the generator drive speed is insufficient. The frequency of the current produced fluctuates between 50 and 60 hertz. The converter dissipates energy in the form of heat.

Document WO 81/01444 provides, between rotor and the generator shaft, a parallel regulation route that passes through a hydraulic, mechanical or electrical variator. The variator is controlled as a function of two signals representative of the speed of the rotor, on the one hand, and of the speed of the generator shaft, on the other. This variator operating as a motor requires a great deal of control energy, consuming at least 10 to 15% of the energy produced by the generator.

In most present-day embodiments, particularly those commented upon hereinabove, the current produced can be used in a local grid, for example a group of houses. However, it is far more difficult, or even impossible, to connect these wind turbines to the national grid.

### SUMMARY

It is an object of the present invention to alleviate at least some of the aforementioned disadvantages with a view in particular to reducing the cost and/or the complexity and/or to improving the energy efficiency and/or frequency stability of the electricity production.

According to the invention, the transmission device for a machine for producing electricity from a variable-speed rotary motive power source, particularly a wind turbine rotor, comprising a supporting structure, an input shaft connected to the motive power source, an output shaft connected to a rotor of the machine, and at least two transmission paths at least one of which passes through a differential mechanism having at least three rotary members, is characterized in that one of the transmission paths comprises two rotary elements which are in a dynamic coupling and kinematic uncoupling relationship and which, because of the fact that each of them is connected to the remainder of the transmission device, have relative to one another a relative speed that causes relative rotation in a regulating apparatus which establishes between the rotary elements a torque that varies in the direction of keeping the rotor of the machine at a set, particularly a substantially constant, speed.

In one embodiment, the variation in torque is defined by a characteristic relationship of the apparatus between its torque and a rotational speed in the apparatus. As an alternative, the variation in torque is defined by a control, particularly a control loop that regulates the speed of the rotor of the machine.

The variation in the torque applied by the regulating apparatus between the two rotary elements makes it possible, in a very simple way, to influence the transmission ratio established by the differential mechanism, and therefore the transmission ratio between the input shaft and the output shaft of the transmission device.

Thus, the transmission device according to the invention makes it possible, if so wished, to maintain a set speed, typically a substantially constant speed, at the input of the electricity producing machine that is powering the grid, even when the rotational speed of the motive power source is extremely low, for example close to one revolution per minute.

The transmission device thus, for example, provides the possibility of constantly keeping the grid powered by the electricity producing machine, thus making it possible to avoid having frequently to adapt the frequency of the electrical current produced by the machine to match the frequency of the grid, and therefore dispensing with the need to provide bulky and expensive equipment for this purpose.

The maximum power of the regulating apparatus may remain extremely limited, for example of the order of 3 to 5%, or even less, of the power of the main machine.

The regulating apparatus may be a motor which injects into the transmission device additional mechanical energy that is found as a supplement on the output shaft for driving the electricity producing machine. If this regulating motor is an electric motor, it may be powered with electricity tapped from that produced by the electricity producing machine.

Preferably, however, according to the invention, the regulating apparatus is an electric generator. Such a generator is able to electrically power various functional members of a wind turbine or other form of electricity producing unit. Such functional members may, for example, be a motor used to orient the wind turbine, or a motor used to orient the blades of the rotor, lighting or illuminated signalling devices, etc. The excess electricity may be used to power accumulator batteries and/or an electric motor that drives the output shaft of the transmission device in order to increase the mechanical power supplied to the electricity producing machine.

When controllable, the generator or other regulating apparatus may be controlled by a unique electrical signal, allowing extremely precise regulation. The electrical signal may be generated after a permanent or cyclic comparison between the rotational speed of the rotor of the producing machine and a preset reference value for this speed. It is also possible to take the rotational speed of the input shaft into consideration in generating a basic value for the signal, the production machine rotor speed being regulated by varying the value of the signal about this basic value.

The regulating apparatus may be an electric generator of the type having a variable number of poles. Such a generator is capable of operating with, between its rotor and its stator, an “electrical” speed which differs from the kinematic speed. This is advantageous in optimizing the efficiency and power of the electric generator when the layout of the transmission device and the expected operating conditions mean that provision needs to be made for wide variations in the kinematic speed of the rotor with respect to the stator in the regulating generator.

It is possible to install the regulating apparatus directly between the two elements. In other words, in the regulating apparatus, there is a relative speed which is equal to the difference in rotational speeds of the two elements. For example, the rotor of an electric generator rotates with one of the elements, while the component commonly known as the “stator” is, in this instance, an element that rotates with the other element. In this arrangement, rotary connections are needed for the energy, typically electrical, coupling of the regulating apparatus, and also for its control and any other operating and regulating links there might be. Furthermore, in the typical example of an electric generator, an apparatus such as this operates satisfactorily only if the relative speed between the rotor and the stator is at least of the order of 1000 revolutions per minute. This means that the regulating apparatus has a certain power value.

The invention proposes an advantageous alternative to the solution that involves mounting the apparatus directly between the two rotary elements. In this advantageous special feature of the invention, the two elements are connected to the two inputs of a comparative differential gearset having a rotary output indicative of the difference, possibly the weighted difference, between the absolute values of the rotational speeds of the two elements, and the shaft of the apparatus is connected to the rotary output.

Typically, the apparatus is then mounted between the rotary output and the supporting structure and, according to another advantageous special feature, the device comprises means for stepping up the rotational speed of the shaft of the apparatus with respect to that of the rotary output of the comparative differential gearset.

Thus, the regulating apparatus may have a fixed stator, and the absolute value of the speed of its rotor or other moving part is considerably reduced. Rotary couplings are no longer needed, and it is possible to have between the two rotary elements a difference in speed which is as low as is wished because the input speed of the apparatus can be stepped up as much as desired with respect to the output speed of the comparative differential gearset.

In one embodiment, the device comprises means for making the two rotary elements rotate in opposite directions to one another. The comparative differential gearset may then be of a type that has planet pinions meshing with two opposed sun gears. The planet pinions are carried by a cage which rotates at a speed equal to the algebraic mean (therefore half the difference of the absolute values when the speeds are the opposite of one another) of the speeds of the two sun gears that each constitutes one of the elements.

A comparative differential gearset capable of providing, at output, a speed indicative of the difference, possibly the weighted difference, between two rotational speeds in the same direction is also conceivable, as will be seen in the description of the examples.

The term “weighted difference” is the term given to the calculated difference between two values (two speeds) multiplied by different coefficients. Thus, for example, a non-zero weighted difference is obtained when the rotational speeds have equal absolute values. This may be beneficial in some embodiments described later on, particularly for generating in the regulating apparatus a speed that is proportionate to the absolute value of the rotational speed of the two elements.

More generally, the invention teaches the creation of a kinematic interruption between two elements which are mechanically in series along a transmission path, connecting these two elements to the two inputs of a comparative differential gearset designed such that the rotary output of this comparative differential gearset rotates at a speed representative of the difference, possibly the weighted difference, between the absolute values of the speeds of the two elements, connecting the rotary output to a dynamic regulating energy tapping apparatus such as an electric generator, a pump, etc., or an injector of energy such as a motor, this apparatus either through its own inherent characteristics or through control associated with it regulating or setting the rotational speed of the transmission path, the torque transmitted by the transmission path, the slip between the rotational speeds of the two elements, etc.

For preference, the transmission path comprising the two elements comprises means for stepping up the rotational speed of each element. Thus, the two elements rotate more quickly and a given difference in speed between the two elements corresponds to a lower power of the regulating apparatus and to a lower proportion of the power passing along the transmission path.

In a simple embodiment, one of the elements is in a relationship for meshing at a fixed ratio with one of the input and output shafts, and the other element is in a relationship for meshing at a fixed ratio with a rotary member of the differential mechanism, which rotary member is itself in a relationship for meshing at a variable ratio with each of the input and output shafts.

In a preferred embodiment, the at least one differential mechanism comprises two differential mechanisms each comprising three rotary members, and the at least two transmission paths comprise three transmission paths each connecting a rotary member of one of the mechanisms to a respective rotary member of the other mechanism.

Typically, the two elements then form part of one of the three paths.

This embodiment makes it possible to ensure that the two elements always rotate at speeds the absolute values of which can be very close to one another if not equal, so that the energy involved in the regulating apparatus can be very small, theoretically as small as is wished, even if the transmission ratio between the input shaft and the output of the transmission device varies in a very wide range.

For preference, one of the three paths is an input path comprising a transmission member secured to the input shaft, and another of the three paths is an output path comprising a transmission member secured to the output shaft. Thus, the transmission device can be considered to comprise two differential mechanisms mounted in parallel between the input shaft and the output shaft, and also coupled to one another by the third transmission path.

The device has a difference between the two differential mechanisms and/or a difference in at least one of the transmission paths and/or a difference in the coupling of the two rotary elements to the regulating apparatus such that the regime of operation of the transmission device is dependent on the dynamic action of the regulating apparatus.

In one embodiment that is particularly suitable when the energy producing machine has to be set to a constant speed and the transmission ratio is therefore a direct function of the speed of the input shaft, the rotational speed applied to the apparatus by the two elements varies as a function of the speed of the input shaft. Thus, the rotational speed of the apparatus defines the transmission ratio.

In the case, such as that of a motive power source consisting of a wind turbine rotor, in which the driving torque applied to the input shaft increases with the rotational speed of the input shaft, it is advantageous for the rotational speed applied to the apparatus to increase when the speed of the input shaft increases. Thus, when the apparatus, such as an electric generator, itself has a torque characteristic that increases with its rotational speed, the increase in the torque of the electric generator accompanies the increase in torque in the transmission path containing the two elements. The assembly may be capable of self-regulating. Finer regulation is achievable, for example, by making the excitation applied to a regulation apparatus consisting of an electric generator vary.

One of the differential mechanisms may be mounted in such a way as to have two of its rotary members connected, respectively, to the input shaft and to the output shaft, and a third rotary member producing a mean, possibly a weighted mean, of the speed of the input shaft and of the speed of the output shaft. The weighting is chosen so that, particularly as a function of the speed of the input shaft, the mean thus obtained, applied at least indirectly to the third rotary member of the other differential mechanism, makes this other differential mechanism produce the desired transmission ratio between the input shaft and the output shaft. In this assembly, as before, one of the transmission paths has a kinematic interruption bridged by a dynamic coupling afforded by the regulating apparatus.

For preference, the two differential mechanisms are identical. In a first version, at least one of the three transmission paths defines, between the two rotary members that it connects, a transmission ratio that differs from that defined by another of the three paths between the two rotary members connected by this other path.

For preference, the mechanisms are identical and two of the three transmission paths define identical transmission ratios, and in particular constitute rigid connections each ensuring common rotation of a rotary member of one of the differential mechanisms and of a respective rotary member of the other differential mechanism.

The third path, which connects the two third rotary members of the two differential mechanisms to one another, may have a different mechanical transmission ratio so as to generate a difference in speed between the two rotary elements.

In a second version, the two differential mechanisms are of identical design and have a difference in tooth ratio. The three transmission paths then preferably define identical transmission ratios.

Advantageously, the two mechanisms are coaxial and at least one of the transmission paths, preferably two of the transmission paths, are connections that ensure common rotation of two rotary members belonging each to one of the mechanisms.

Particularly in applications such as wind turbines that require high step-up ratios for the speed of the output shaft with respect to the speed of the input shaft and/or a wide range of ratios, the differential mechanism is preferably produced in the form of an epicyclic gearset comprising a sun gear connected to the output shaft, a ring gear consisting of a rotary reaction member, and a planet carrier connected to the input shaft and supporting at least one set of two planet pinions mounted in cascade, and of which one meshes with the sun gear and the other with the ring gear. A differential mechanism of this type has the notable special feature of providing a step-up ratio that varies from one to infinity as the speed of the ring gear varies, respectively, from a speed equal to the speed of the sun gear to a speed equal to a fraction of the speed of the sun gear. Said friction is equal to the tooth ratio between the sun gear and the ring gear. It is very advantageously possible to select such a differential mechanism in which the number of teeth on the ring gear is twice that of the sun gear.

A second subject of the invention is a unit for producing electricity comprising a transmission device according to the first subject and an electricity producing machine of synchronous type. The invention in effect allows the rotational speed of the electricity producing machine to be perfectly stabilized thus allowing this machine to deliver a current that is stable in terms of frequency and in terms of phase.

For preference, the electricity producing unit comprises a sensor that senses the rotational speed of the rotor of the electricity producing machine, and a control loop that regulates this rotational speed, which controls the apparatus as a function of the difference between the rotational speed of the rotor and a set point.

A third subject of the invention is a wind turbine comprising a transmission device according to the first subject and/or an electricity producing unit according to the second subject.

According to another aspect of the invention, the method for setting a transmission ratio between a motive power source and a load, is characterized in that two differential mechanisms are placed between the motive power source and the load, these differential mechanisms each having at least three rotary members, each rotary member of one of the mechanisms being connected to a respective rotary member of the other mechanism by a respective transmission path, one of the paths comprising two rotary elements that are connected by the action of a dynamic coupling apparatus, and the coupling apparatus is regulated.

Other specific features and advantages of the invention will become further apparent from the description which follows, which relates to some nonlimiting examples.

### BRIEF DESCRIPTION OF THE DRAWINGS

FIG. 1 is a schematic axial view of a first embodiment of a wind turbine according to the invention.

FIG. 2 is an outlined front view of the epicyclic gearset used in the wind turbine of FIG. 1.

FIG. 3 is half a front-on view of the epicyclic gearset, illustrating some of its dimensional, geometric and operating features.

FIGS. 4 to 10 are views similar to FIG. 1 but relating to other embodiments.

FIGS. 11 and 12 depict two alternative forms of comparative differential.

### DESCRIPTION OF PREFERRED EMBODIMENTS

The hatching drawn onto the rotary elements indicates the directions in which they rotate. In the case of the planet pinions, these rotate about their own axis.

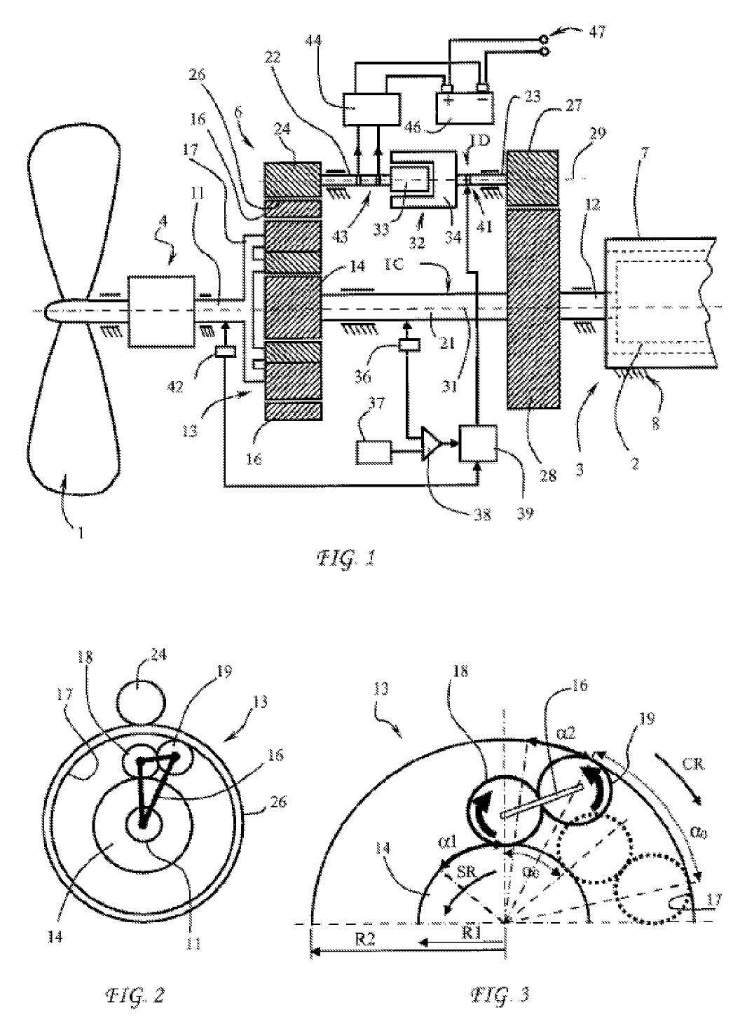

In the example depicted in FIG. 1, the wind turbine, which is depicted only in part, comprises a wind turbine rotor 1 which drives the rotor 2 of an electricity producing machine 3 via input step up gearing 4 followed by a transmission device 6 according to the invention. The stator 7 of the machine 3 is fixed to a supporting structure 8 depicted only symbolically. By virtue of the invention, the electricity producing machine 3 can be a synchronous generator rotating at a perfectly stabilized speed, for example 1500 revolutions per minute, producing in a stable manner a 50 hertz current compatible with the grid. The wind turbine rotor 1 rotates at a highly variable speed typically ranging between 1 and 30 revolutions per minute depending on the strength of the wind. The step up gearing 4 increases this speed by stepping it up by a constant factor, for example a factor of 50. The output shaft of the step up gearing 4, which at the same time constitutes an input shaft 11 of the transmission device 6, thus, in this example, rotates at a speed ranging between 50 and 1500 revolutions per minute. The transmission device 6 establishes a transmission ratio which varies continuously to step up by a factor of 30 to 1 the rotational speed of its output shaft 12 secured to the rotor 2 of the machine 3 with respect to the rotational speed of its input shaft 11.

The transmission device 6 comprises a differential mechanism 13, in this example a planetary or epicyclic gearset, made up of three rotary members, namely a sun gear 14 connected to the output shaft 12, a ring gear 16 constituting a reactive rotary member, and a planet carrier 17 connected to the input shaft 11. The planet carrier 17 supports at least one set of two planet pinions 18, 19 mounted in cascade, which mesh with one another. The planet pinion 18 meshes with the external tooth set of the sun gear 14 and the planet pinion 19 meshes with the internal tooth set of the ring gear 16.

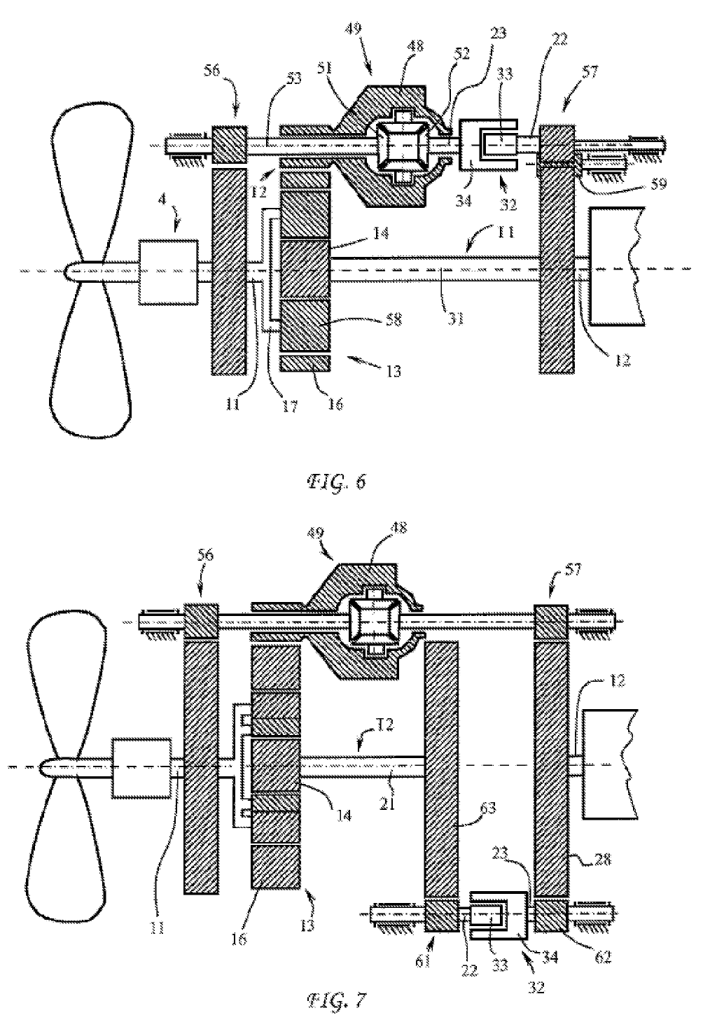

This type of epicyclic gearset with pairs of planet pinions in cascade has the following special features: for a transmission ratio of 1:1 between the input shaft 11 and the output shaft 12, the sun gear 14, the ring gear 16 and the planet carrier 17 rotate at the same speed. For a transmission ratio equal to 30:1 (rotational speed of the output shaft 12 thirty times that of the input shaft 11), the ring gear 16 rotates in the same direction as the input 11 and output 12 shafts and at a speed which is close to the rotational speed of the sun gear 14 multiplied by the ratio R1/R2. In this expression, R1 is the tooth set radius of the sun gear and R2 is the tooth set radius of the ring gear 16 (see FIG. 3). In other words, notably, if a very reasonable value of 1/2 is chosen for the ratio R1/R2, then the rotational speed of the ring gear 16 will always be in the same direction and will vary only by a factor of 2 when the input speed Ve, and with it the overall transmission ratio Vs/Ve, vary by a factor of 30. The reactive torque CR to be applied to the ring gear 16 needs to be directed in the opposite direction to the direction of rotation SR of the input shaft 11. In the depiction in FIG. 3, a rotation performed by the planet carrier 17 between the position depicted in dotted line and the position depicted in solid line is denoted α₀. When all three rotary members 14, 16, 17 are rotating in the same direction, the sun gear 14 and the ring gear 16 each perform a rotation equal to the rotation α₀ of the planet carrier 17, increased by an angle α₁ and α₂ respectively. These two angles are in the ratio α₂/α₁=R1/R2 because they correspond to equal arc lengths.

Thus, the transmission ratio is equal to (α₀+α₁)/α₀. The angle α₀ represents the input speed Ve of the input shaft 11 and (α₀+α₁) represents the output speed Vs that is to be set to 1500 revolutions per minute. From the foregoing, the speed Vc of the ring gear 17 can be calculated as follows: Vc=Ve+(Vs−Ve)(R1/R2).

The transmission device according to the invention regulates the rotational speed Vc of the ring gear 16 so that by virtue of the above relationship, the output shaft 12 rotates at the desired value Vs and/or so that the ratio Vs/Ve adopts the desired value.

To allow control over the rotational speed of the ring gear 16, the transmission device 6 according to the invention defines, between the input shaft 11 and the output shaft 12, two transmission paths TC and TD. The kinematic path TC comprises the differential mechanism 13 and an intermediate shaft 21 rigidly connecting the sun gear 14 to the output shaft 12. The dynamic path TD comprises the differential mechanism 13 and a kinematic interruption bridged by a special dynamic link between the ring gear 16 and the output shaft 12.

More specifically, the transmission path TD comprises two rotary elements 22, 23 which are in a power transmission relationship while at the same time being kinematically decoupled and having a relative speed that causes one to rotate relative to the other. In this particular embodiment, the first rotary element 22 rotates at a speed which is at a fixed ratio to the rotational speed of the ring gear 16. For that, the first rotary element 22 is secured to a pinion 24 which meshes with an external tooth set 22 of the ring gear 16. The second rotary element 23 rotates at a speed which is in a fixed ratio with the speed of the output shaft 12. For that, the second rotary element 23 is secured to a pinion 27 which meshes with a gearwheel 28 secured to the output shaft 12. The intermediate shaft 21 extends between the sun gear 14 and the gearwheel 28. Thus, the transmission paths TC and TD are connected to one another at one end by the differential mechanism 13 and at the other end by the gearwheel 28 because it rotates as one with the intermediate shaft 21 and meshes in a fixed ratio with the pinion 27. The two rotary elements 22 and 23 are mounted to rotate about a common geometric axis 29 which is fixed and situated parallel to and at a certain distance from the overall axis 31 of the output 12 and input 11 shafts, which is also the axis of the differential mechanism 13 and of the intermediate shaft 21.

A regulating apparatus 32 is fitted to establish between the rotary elements 22 and 23 a torque which varies in the direction of keeping the rotor 2 of the machine 3 at a set, particularly substantially constant, speed.

In the example depicted, the regulating apparatus 32 is an electric generator, for example an alternator, the rotor 33 of which is secured to the element 22 rotating at a set speed with respect to the ring gear 16. The stator 34 of the electric generator 32, instead of being fixed like a conventional stator, in this instance is a rotary stator that rotates as one with the second rotary element 23 rotating at a set speed with respect to the output shaft 12.

The tooth ratios between the pinion 24 and the external tooth set 26 of the ring gear 16, on the one hand, and between the pinion 27 and the gearwheel 28 on the other, are such that: i) the rotary elements 22 and 23 rotate in the same direction, and ii) the rotational speed of the rotary element 22 coupled to the ring gear 16 is always greater than that of the rotary element 23 coupled to the output shaft 12.

In the example where R2/R1=2, the smallest possible speed for the ring gear 16 is equal to half that of the output shaft 12. It is thus possible to be sure that the first rotary element 22 always rotates more quickly than the second rotary element 23 by stepping up the rotational speed of the element 22 with respect to the ring gear 16 by twice as much as the rotational speed of the element 23 with respect to the output shaft 12.

In general, these step-up ratios are chosen to be relatively high so that the rotary elements 22 and 23 rotate at relatively high speeds by comparison with the rotational speed of the input shaft 11 and of the output shaft 12. For example, it is possible to contrive for the second element 23 to rotate at 14,000 revolutions per minute and for the first element 22 to rotate at between 15,000 and 30,000 revolutions per minute.

At all operating speeds, the rotor 33 rotates more quickly than the rotary stator 34. The electromagnetic forces there are between the rotor 33 and the stator 34 are in the direction that tends to slow the rotor 33 and therefore the ring gear 16, and in the direction that tends to accelerate the stator 34 and therefore the output shaft 12. Energy transfer is therefore from the differential mechanism 13 to the output 12 along the dynamic transmission path TD. It is also from the input shaft 11 to the output shaft 12 through the kinematic transmission path TC because the sun gear 14 experiences, from the planet pinion 18, a torque in the direction SR (FIG. 3) of rotation of the gear 14. Thus, in this embodiment, both transmission paths are driving for the output shaft 12.

The torque transmitted through the dynamic transmission path TD is proportionate to the input torque present on the input shaft 11. Because the speed Vs of the output shaft 12 is constant, the rotational speed of the rotor 33 with respect to the stator 34 is a function only of the rotational speed Ve of the input shaft 11. Further, in the special case of a motive power source such as a wind turbine, the torque on the input shaft 11 increases, for example proportionately, with the rotational speed Ve of the input shaft 11. As a result, the regulation according to the invention entails that the electromagnetic torque between the rotor 33 and the stator 34 needs to increase when the rotational speed of the rotor 33 increases with respect to the stator 34. By choosing a regulating apparatus 32 that has a characteristic curve that is suitably chosen in respect of its torque as a function of the rotational speed of its rotor with respect to its stator, a transmission device is created that is capable automatically of stabilizing the rotational speed of the rotor 2 of the electricity producing machine 3 without the need for a regulating control circuit.

However, in the example depicted, with a view to achieving finer regulation and better precision on the rotational speed of the rotor 2 of the electricity producing machine 3, a regulating device is provided. It comprises a sensor 36 that senses the rotational speed of the output shaft 12, a memory or the like 37 for a reference setpoint value for the rotational speed of the stator 2, a comparator 38 for determining any difference there might be between the actual speed of the output shaft 12 and the setpoint value, and a circuit 39 for converting the output from the comparator 38 into an excitation current applied to the stator 34 via one or more rotary contacts 41 provided on the rotary element 23. In the example depicted, by way of an improvement, there is also a sensor 42 that senses the rotational speed Ve of the input shaft 11. The sensor 42 sends a signal to the circuit 39 to select ranges of excitation current values as a function of the speed Ve. When the rotational speed Vs of the output shaft 12 tends to become insufficient, the excitation of the generator 32 is increased to slow the ring gear 16 still further and thus encourage a slight increase in the transmission ratio between the input shaft 11 and the output shaft 12. Conversely, for reasons of symmetry, if the speed Vs tends to become excessive, the control and regulating circuit slightly reduces the excitation in order to allow the transmission ratio to drop.

In a way that has not been depicted, a continuously varying automatic speed change device or one with a finite number of ratios may be interposed in the transmission path TD, for example between the pinion 24 and the stator 33. The automatic control of this device tends constantly or cyclically to regulate the rotational speed of the rotor 33 so that it exhibits an optimum difference with respect to that of the stator 34. This then improves the efficiency of the regulating generator 32 and the power absorbed by the generator 32 can be reduced considerably, especially by reducing the speed differential between the rotor 33 and the stator 34 for high values of input shaft 11 speed Ve. In principle, the control circuit described previously automatically corrects the excitation of the generator 32 as a function of the transmission ratio established by the speed change device. It is also conceivable to provide, in the circuit 39, an input for a signal informing the circuit 39 of the ratio established by the speed change device. The circuit 39 is thus able to anticipate the variations in excitation to be performed rather than reacting to fluctuations in the rotational speed of the rotor 2 of the machine 3. Moreover, the presence of the speed change device makes it possible to provide, between the ring gear 16 and the pinion 24, on the one hand, and between the gear wheel 28 and the pinion 27 on the other, ratios different from those previously described and which in any case were given merely by way of example.

As an alternative or in addition to the speed change device, it is possible to produce the generator 32 in the form of a changing-pole generator. This known type of generator performs a variable electrical rotation of the stator poles with respect to the mechanical structure of the stator. In this way it is possible to modify, and in particular to optimize, the difference in electrical speed between the rotor and the stator. To do that, the circuit 39 may be designed to apply an appropriate command to the stator 34 through the rotary contacts 41 or any other rotary contact provided in addition, taking into account for example the signal supplied by the detector 42 representative of the input speed Ve.

The electricity produced by the generator 32 is collected by rotary rotor contacts 43 provided, for example, on the periphery of the rotary element 22. This electrical energy then for example reaches a rectifier 44 to charge batteries 46 and/or to power the terminals of one or more electricity using devices 47.

In the examples which will follow, neither the electronic control means nor the means of collecting the energy produced by the generator 32 have been depicted, nor will these be described further. These means may, at least in theory, be similar to those described and depicted with reference to FIG. 1.

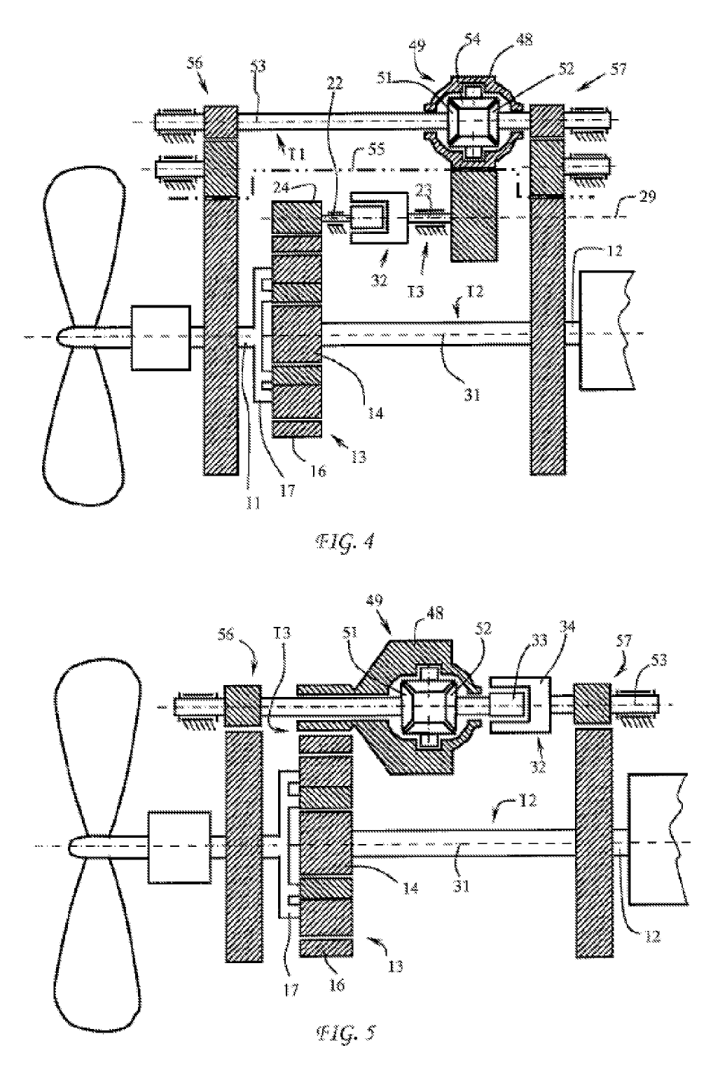

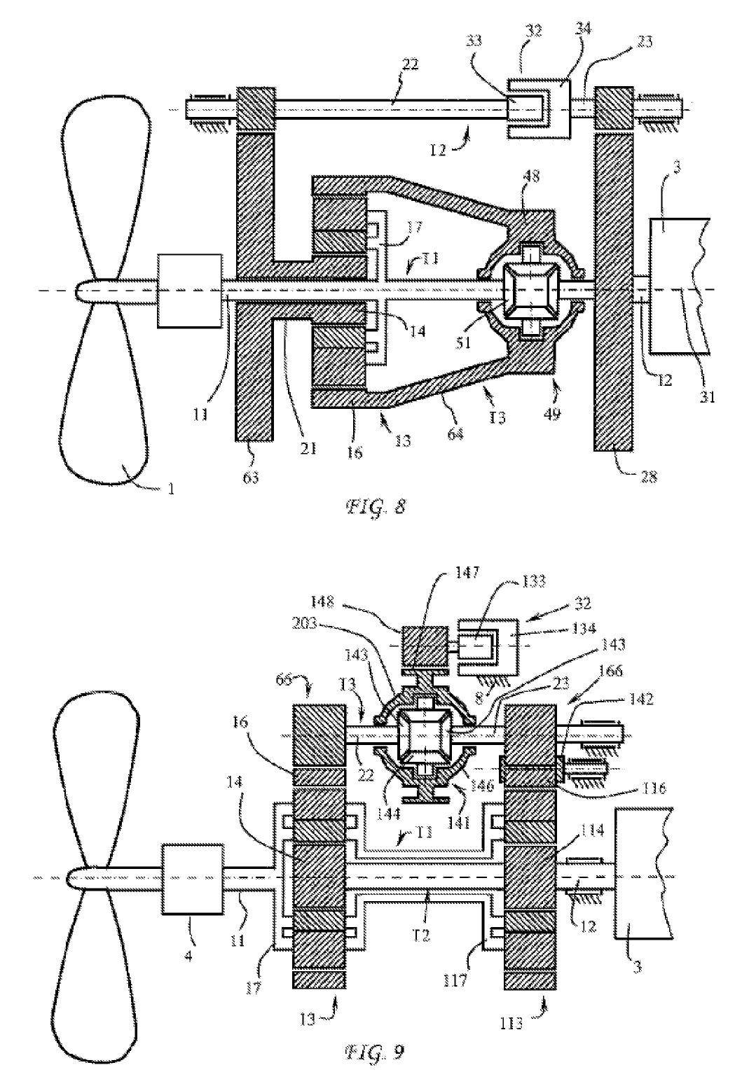

The example depicted in FIG. 4 will be described only in terms of its differences by comparison with that of FIGS. 1 to 3.

Instead of being in a fixed speed ratio with the output shaft 12, the second rotary element 23 is now in a fixed transmission ratio with the third rotary member or cage 48 of a second differential 49. The first two rotary members of the second differential 49 are two bevel sun gears 51, 52 having identical tooth sets and arranged facing one another. These two sun gears are in a fixed transmission ratio, one of them (51) with the input shaft 11, and the other (52) with the output shaft (12). These three rotary members 48, 51, 52 have a common axis of rotation 53 that is fixed relative to the supporting structure and is parallel to and spaced away from that 29 of the rotary elements 22 and 23 and that 31 of the input 11 and output 12 shafts.

Bevel planet pinions 54 are mounted to rotate freely inside the cage 48 about axes perpendicular to the axis 53. Each bevel plant pinion 54 meshes with the two sun gears 51 and 52. In such a differential, the cage 48 rotates about the common axis 53 at a speed that is equal to the algebraic mean of the rotational speeds of the two sun gears. In this particular instance, the setup is such that the two sun gears rotate in the same direction. Thus, the cage 48 rotates at a speed which represents an arithmetic mean of the speed of the input 11 and output 12 shafts.

In this example, the two rotary members 16, 48 which are connected by the third path tend, one of them (16), to reduce the transmission ratio of its differential mechanism when its speed increases, and the other (48) to increase the transmission ratio of its differential mechanism when its speed increases.

The principle underlying this embodiment is as follows: when the speed Ve of the input shaft 11 varies from 50 to 1500 revolutions per minute, the speed of the ring gear 16 needs to vary from about 750 to 1500 revolutions per minute, which is like the variation in the mean of the speed of the input shaft and that of the output shaft. The idea is to generate a speed representative of this mean and to apply it directly or indirectly to the ring gear 16. In the example depicted, in which the regulating apparatus 32 is interposed between the cage 48 and the ring gear 16, and in which the ring gear 16 has to experience a torque in the opposite direction to its direction of rotation, a speed carefully generated from the input and output speeds so that this speed varies in a similar way to the speed desired for the ring gear, but still lower than this speed, is applied to the second rotary element 23, that is to say to the stator of the generator 32. Thus, there is always, between the stator and the rotor of the generator 32, a difference in speed which varies little and which represents a small proportion of the speed of the elements 22 and 23, so that the power absorbed by the generator 32 is low at all operating speeds of the transmission device.

A typical regulating apparatus such as an electric generator needs to have at least a certain level of rotor speed by comparison with the stator speed in order to work properly, for example at least a thousand revolutions per minute of difference. For such a speed difference to represent only a small fraction of the speed of the rotary elements 22 and 23, it is advantageous to provide means for stepping up the speed of the rotary elements 22 and 23 with respect to those of the input shaft 11 and of the output shaft 12.

In the example depicted, the pinion 24 secured to the rotary element 22 has, for example, a diameter equal to 1/20 of that of the external tooth set of the ring gear 16. The element 22 therefore rotates twenty times faster than the ring gear 16. Step-up gearsets 56 and 57 are also provided between the input shaft 11 and the sun gear 51, on the one hand, and between the output shaft 12 and the sun gear 52 on the other. Thus, the rotational speed of the cage 48 has a value that is amplified with respect to the arithmetic mean of the speeds Ve and Vs. This amplified mean is transmitted to the rotary element 23 in a ratio 1:1.

It is also sensible for the mean speed supplied by the cage 48 to correspond to a weighted mean. Thus, the relationship between the rotational speed of the cage 48 on the one hand, and the ratio Ve/Vs on the other, can be finely adjusted.

This is easier to understand when considering a numerical example based on the aforementioned values. The ring gear 16 rotates at 750 to 1500 revolutions per minute. The element 22 rotates twenty times faster, that is to say at 15,000 to 30,000 revolutions per minute. If the difference in speed between the elements 22 and 23 is desired to vary by 1,000 to 2,000 revolutions per minute then the element 23, and therefore the cage 48, have to rotate at 14,000 to 28,000 revolutions per minute. This is (approximately) achieved if the step up ratio of the gearset 56 is 19:1 and if the step up ratio of the gearset 57 is 18:1. With such a choice, the energy absorbed by the generator 32 is of the order of 6 to 7% of the energy flowing along the transmission path T3.

In the depiction of FIG. 4, the three geometric axes 29, 31, 53 are depicted as being coplanar. This is not absolutely essential; the elements situated above the line 55 can be swung out of the plane of the figure by adapting the diameters in the gearsets 56 and 57 accordingly, while at the same time maintaining the desired ratios.

The principle underlying this version of the invention, and the versions which will be described hereafter, can be visualized in a different way: two differential mechanisms 13, 48 are mounted in parallel between the input shaft 11 and the output shaft 12. Each of these differential mechanisms has an input member 17, 51 connected to the input shaft 11, an output member 14, 52 connected to the output shaft 12, and a reaction member 16, 48. The two reaction members 16, 48 are joined together by a transmission path T3 but are not in a fixed ratio either with the input shaft 11 or with the output shaft 12. Somewhere in the connections between the rotary members of the two mechanisms there is a kinematic interruption bridged by a dynamic coupling (generator 32).

Energy is tapped from the transmission device through this dynamic coupling. It is also possible to conceive of replacing the generator with a motor, powered by the machine 3, which would inject a variable amount of energy into the transmission device. Energetic activation of the dynamic coupling is the result of a sensible choice of all of the tooth ratios in the transmission device. This choice means that each differential mechanism receives, from the other differential mechanism, a stress the level of which is set directly or indirectly by the dynamic coupling.

In the example depicted in FIG. 4, the two differential mechanisms can establish the same transmission ratio between the input shaft 11 and the output shaft 12 only if the speed of their reaction members 16, 48 is in a relationship other than the one that would correspond to the elements 22 and 23 being secured to one another. Because the two differential mechanisms are indeed forced to establish the same transmission ratio between the input shaft 11 and the output shaft 12, there is, between the elements 22 and 23, a speed difference which is a function of the ratio Vs/Ve. The transmission ratio Vs/Ve can thus be set by regulating the difference in speed between the elements 22 and 23. This difference in speed is regulated by controlling the activation of the dynamic coupling 32.

There is yet a third way of describing the embodiment of FIG. 4 and the embodiments which will follow. Two differential mechanisms 13, 49 are connected by three transmission paths. A first path T1, or input path, connects, in set tooth ratios, the input shaft 11 with an input member 17 of the first mechanism 13 and an input member 51 of the second mechanism 49. A second path T2, or output path, connects in set tooth ratios the output shaft 12 with an output member 14 of the first mechanism 13 and an output member 52 of the second mechanism 49. A third path T3, or reaction path, connects, in set ratios, a reaction member 16 of the first mechanism 13 with a reaction member 48 of the second mechanism 49. Somewhere in one of the three paths there is a kinematic interruption bridged by a dynamic coupling. Furthermore, in the differential mechanisms and/or in the tooth ratios of the three paths, and/or in the connecting of the rotary elements 22, 23 to the regulating apparatus, there is a special feature whereby the regulating apparatus is activated differently according to the overall transmission ratio Ve/Vs and/or according to the input speed Ve and/or according to the torque transmitted. A characteristic curve of the regulating apparatus and/or control of the regulating apparatus allow the overall transmission ratio Ve/Vs to be controlled.

The embodiment of FIG. 5 will be described only in terms of its differences by comparison with that of FIG. 4.

In this embodiment, the dynamic coupling by the regulating apparatus 32 is inserted not in the third transmission path T3 between the ring gear 16 and the cage 48 but this time in the second path or output path T2. More specifically, the kinematic interruption bridged by the dynamic coupling 32 is placed between the output member 52 of the second differential mechanism 49 on the one hand, and the step up gearing 57 of the connection with the output shaft 12. The third transmission path T3 is considerably simplified because it consists of direct meshing between the periphery of the ring gear 16 and the cage 48. There are now just two geometric axes, the overall axis 31 and the axis 53 which is now common to the differential 49 and to the generator 32. There is one fewer intermediate pinion in each of the step up gearsets 56 and 57.

The embodiment of FIG. 6 will be described only in terms of its differences in relation to that of FIG. 5.

In this embodiment, the differential mechanism 13 is of a type with simple planet pinions 58, rather than with pairs of planet pinions in cascade. Each planet pinion 58 meshes with the sun gear 14 and with the internal tooth set of the ring gear 16.

Such a differential mechanism provides a high step up ratio of the sun gear 14 with respect to the planet carrier 17 when the ring gear 16 is rotating in the opposite direction to the planet carrier 17 and to the sun gear 14. By choosing, for example, for the internal tooth set of the ring gear 16, a diameter three times that of the sun gear 14, the step up ratio reaches 3:1 when the ring gear is held stationary, and 90:1 when the ring gear is rotating 43.5 times as fast as the input shaft 11.

For its part, the step up gearing 4 produces a step up ratio which is now only about 17:1 which means that the rotational speed of the input shaft 11 now varies from 17 to 500 revolutions per minute. The transmission device has to provide its maximum step up ratio when the speed of the input shaft 11 is equal to 17 revolutions per minute. That gives, for the ring gear 16, a maximum speed of 17×43.5=740 revolutions per minute, which is therefore very reasonable.

The issue is therefore that of causing the rotational speed of the ring gear 16 to vary between −740 and 0 revolutions per minute. This is achieved by causing the cage 48 to produce a mean of i) the speed of one of the input 11 and output 12 shafts and ii) the inverse speed of the other of these shafts 11 and 12. Thus, in the gearset 57, there is a reverse idler pinion 59 whereas the gearset 56 comprises no reverse idler pinion.

Further, the step up ratio of the gearset 56 is approximately three times higher than that of the gearset 57.

When the input speed is very low, the speed of the cage 48 is more or less representative of half the speed of the output shaft 12. By contrast, when the input speed is at its maximum (500 revolutions per minute), its value stepped up by a factor of three more than that of the output shaft is introduced into the differential mechanism 49 in the opposite direction with the effect that the mean supplied by the cage 48 is equal to 0. The speed of the cage 48 therefore varies in the desired way in relation to the speed of the input shaft 11. It is transmitted in the appropriate direction to the ring gear 16 so that the latter rotates in the opposite direction to the input and output shafts 11 and 12.

In this embodiment, the torque to be applied to the ring gear 16 needs to be in the same direction as its rotation. For this reason, the generator 32 has to be driving in respect of the ring gear 16 rather than just mechanically resistant. The mounting of the generator has therefore been reversed by comparison with the preceding exemplary embodiments, so that its rotary stator 34 is on the same side as the ring gear 16, and its rotor 33 is on the same side as the speed reference, that is to say in a fixed ratio with one of the input and output shafts, in this example the output shaft 12.

Of course, like in the previous examples, the step up ratios in the gearsets 56 and 57 and between the ring gear 16 and the cage 48 are carefully chosen to optimize the law governing the relative speed between the stator and the rotor in the regulating apparatus 32.

The embodiment of FIG. 7 is another modification to the embodiment of FIG. 5 and will therefore, like the embodiment of FIG. 6, be described only in terms of its differences in relation to the embodiment of FIG. 5.

The kinematic interruption, with dynamic coupling by the regulating apparatus 32, is positioned this time again in the second transmission path or output path T2, but this time between the sun gear 14 of the first mechanism 13 and the gearwheel 28. In other words, the intermediate shaft 21 is now interrupted. The rotor 33 on the one hand and the stator 34 on the other are coupled to the sun gear 14 and to the gearwheel 28 respectively by step-up gearsets 61, 63 and 62, 28. The tooth ratios are for example chosen so that that one of the rotary elements 22 and 23 which is coupled to the sun gear 14 rotates more quickly than the other one.

The embodiment of FIG. 8 will be described only in terms of its differences in relation to that of FIG. 7.

In this embodiment, the two differential mechanisms are coaxial along the overall axis 31. The input transmission path T1 is a rigid coupling of the input shaft 11 with the planet carrier 17 and with the input sun gear 51 of the mechanism 49. The third transmission path T3 is a bell housing 64 rigidly connecting the ring gear 13 and the cage 48. The sun gear 14, the intermediate shaft 21 and the gearwheel 63 form a tubular assembly free to rotate about the input shaft 11. The gearwheel 63 is on the wind turbine rotor 1 side of the sun gear 14. The two differential mechanisms 13, 49 are positioned spatially between the gearwheels 63 and 28.

This embodiment operates in a similar way to the preceding one. It requires fewer gearsets. However, the second differential mechanism 49 experiences more or less the same torques as the first mechanism 13, rather than torques that have been reduced by step up gearing as was the case in the preceding examples.

The embodiment of FIG. 9 will be described only in terms of its differences in relation to that of FIG. 8.

A first series of differences relates to the differential mechanisms 13, 113 which have the same design, as per FIG. 1, and identical tooth ratios. For preference, these two mechanisms have identical components, to simplify manufacture, reduce costs and component part stocks. The first transmission path T1 rigidly connects the input shaft 11 to the two planet carriers 17, 117. The second transmission path T2 rigidly connects the two sun gears 14, 114 and the output shaft 12. The third transmission path T3 connects the two ring gears 16, 116, passing via a kinematic interruption bridged by a dynamic coupling that will be described later on.

Given that the two differential mechanisms are identical, and that their sun gears 14, 114 rotate as one as do their planet carriers 17, 117, the two ring gears 16, 116 also rotate at the same speed, and in the same direction. However, the rotary elements 22 and 23 have different rotational speeds because they are coupled to the ring gear 16 and to the ring gear 116 by respective step up gearsets 66 and 166 that have slightly different ratios. The difference in speed between the elements 22 and 23 is proportional to the speed of the ring gears 16, 116, which is itself dependent on the transmission ratio Vs/Ve. The dynamic action exerted by the regulating apparatus 32 is able to influence the difference in speed between the elements 22 and 23, and thus the overall transmission ratio.

Another series of differences, independent from the first, relates to the way of dynamic coupling between the elements 22 and 23. The rotor 133 and the stator 134 are no longer directly connected each to one of the elements 22 and 23 but rather a means for producing a speed representative of the difference between the speeds of the elements 22 and 23 has been installed between the elements 22 and 23. A differential 141 of conventional design performs this function provided that the shafts 22 and 23 are rotating in opposite directions. This is why the step up gearset 166 comprises a reverse idler pinion 142 whereas such a pinion is not provided in the step up gearset 66. Each of the elements 22 and 23 is connected to a respective one of the two input sun gears 143 of the comparative differential 141. These two bevel sun gears 141 arranged symmetrically facing one another mesh with bevel planet pinions 144 mounted to rotate freely on one or more axes perpendicular to that of the elements 22 and 23 in a rotary cage 146. In operation, the cage rotates at a speed equal to half the difference between the absolute values of the speeds of the elements 22 and 23. On its periphery, the cage 146 has a ring gear 147 which meshes with a step up pinion 148 secured to the rotor 133 of the regulating apparatus 32. The stator 134 of the apparatus 32 is fixed to the supporting structure.

This method of dynamic coupling is particularly advantageous because is considerably reduces the speed of the rotor and allows the stator of the regulating apparatus to be kept fixed. The setup is therefore far more conventional, and there is no longer any need for rotary contacts for the stator.

Furthermore, in the above embodiments with a rotary stator, a minimum speed difference between the elements 22 and 23 was required in order for the regulating apparatus to operate correctly. Given the maximum rotational speeds of the order of 30,000 revolutions per minute that ought really not to be exceeded in order not to have to resort to special and expensive components, the percentage energy involved in the regulating apparatus is at least of the order of 5% of the energy transmitted by the dynamic coupling. With the structure of FIG. 9, there may be a far lower difference in speed between the elements 22 and 23. The lower it is, the more the step-up ratio of the pinion 148 with respect to the cage 146 can be increased in order in all cases to obtain an appropriate range of speeds for the rotor 133.

The embodiment of FIG. 10 will now be described according to its differences in relation to that of FIG. 9. The two ring gears 16, 116 are now rigidly joined together. By contrast, the output transmission path T2 connecting the two sun gears 14, 114 has a kinematic interruption bridged by a dynamic coupling of the same kind as the one described in FIG. 9.

If the two differential mechanisms were identical as in FIG. 9, then the difference in speed between the rotary elements 22 and 23 would be constant because it would be proportionate to the rotational speed of the output shaft 12. Nonetheless, the torque of the generator 32 would be able to be set in order to regulate the transmission ratio. In other words, regulating the rotational speed of the output shaft 12 would at the same time regulate the rotational speed of the rotor of the generator 32.

In the example depicted, provision has been made for the difference in speed between the elements 22 and 23 not to be constant as mentioned in the previous paragraph, but to vary as a function of the speed of the input shaft 11. For that, use is made of two differential mechanisms 13, 113 which, although admittedly of identical design, have slightly different tooth ratios. In spite of that, a difference in step up ratio between the step up gear sets 66 and 166 is maintained. Thus, there is a difference in speed between the elements 22 and 23 even when the transmission device is operating in direct drive and the two sun gears 14 and 114 are therefore rotating at the same speed.

In a way that has not been depicted, this embodiment can be achieved with two differential mechanisms like the one 13 in FIG. 6, that is to say with a simple planet pinion and ring gear rotating in the opposite direction. It is even possible to conceive of an operation with a ring gear rotating alternately in one direction and in the other. This makes it possible to operate a differential mechanism with a simple planet pinion as described in FIG. 6 between a transmission ratio of 30:1 (where the ring gear rotates in the opposite direction at approximately 13.5 times the input speed) and a transmission ratio of 1:1 (in which the ring gear rotates in the same direction and at the same speed as the input shaft).

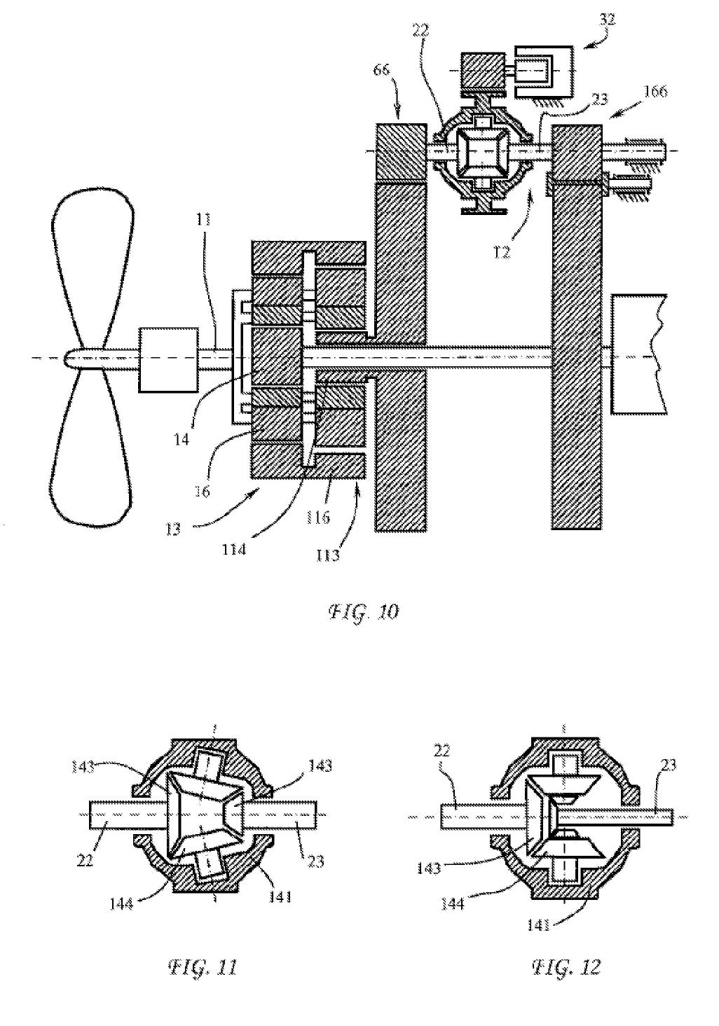

The embodiments of FIGS. 11 and 12 vary in terms of the comparative differential.

In the embodiment of FIG. 11, the two sun gears 143 have different diameters and the planet pinions 144 have oblique axes. The cage 141 rotates at a speed proportionate to that of the elements 22 and 23 when they have the same speed. With reference to FIG. 9, there is no longer any need to provide different ratios for the step up mechanisms 66 and 166. It suffices for one of them to have a reversing facility and for the other not to.

In the embodiment of FIG. 12, there is no need for one of the step-up devices to have a reversing facility. Reversing is achieved in the differential. Each planet pinion 144 has coaxial tooth sets meshing each with one of the sun gears 143. The two sun gears 143 are positioned on one and the same side of the axes of the planet pinions. By choosing different tooth ratios for each sun gear 143 with the associated planet pinion tooth set, it is also possible to make the rotation of the cage 141 proportionate to the speed of the elements 22 and 23 when these are rotating at the same speed. This embodiment allows the two step up devices 66 and 166 to be produced strictly identically, even if the two differential mechanisms are also identical.

Of course, the invention is not restricted to the examples described and depicted. The dynamic coupling system with comparative differential can be read across to the other embodiments, particularly those of FIGS. 4 to 8. The comparative differential may be other than the cage type. For example, one of the rotary elements could be connected to the ring gear of a conventional epicyclic gearset, with the other rotary element connected to the sun gear of the epicyclic gearset, the two rotary elements rotating in opposite directions and being driven by step up devices with transmission ratios that, for example, cause the ring gear to rotate at approximately half the speed of the sun gear so that the speed of the planet carrier is low.

In the embodiment of FIG. 1, the kinematic path TC and the dynamic path TD could be installed between the input shaft 11 and the differential mechanism 13.

In embodiments such as those of FIGS. 4 to 12, it might be possible to position the kinematic interruption bridged by a dynamic coupling into the input transmission path, between the input shaft 11 and the rotary input member of either one of the two differential mechanisms.

In most of the examples, the difference in speed between the two rotary elements 22 and 23 has been described as being a value that increases when the speed of the input shaft increases and the transmission ratio decreases. In the example of a wind turbine in which the increase in input speed goes hand in hand with an increase in transmitted torque, this direction of variation of the difference in speeds between the two rotary elements contributes to regulating the transmission device because the regulating apparatus 32 also, in general, has a characteristic whereby its torque increases as a function of speed. However, it is also conceivable to contrive for the difference in speed not to vary or for it to vary in the opposite direction to that which has just been discussed.

1-31. (canceled)

32. A transmission device for a machine for producing electricity from a variable-speed rotary motive power source comprising a supporting structure, an input shaft connected to the motive power source, an output shaft connected to a rotor of the machine, and at least two transmission paths at least one of which passes through at least one differential mechanism having at least three rotary members wherein one of the transmission paths comprises two rotary elements which are in a dynamic coupling and kinematic uncoupling relationship and which, because of the fact that each of them is connected to the remainder of the transmission device, have relative to one another a relative speed that causes relative rotation in a regulating apparatus which establishes between the rotary elements a torque that varies in the direction of keeping the rotor of the machine at a set, substantially constant speed.

33. The transmission device as claimed in claim 32, wherein the two elements are connected to the two inputs of a comparative differential gearset having a rotary output indicative of the difference between the absolute values of the rotational speeds of the two elements, and in that a rotary part of the apparatus is connected to the rotary output.

34. The transmission device as claimed in claim 33, wherein it comprises means for stepping up the rotational speed of the rotary part of the apparatus with respect to that of the rotary output of the comparative differential gearset.

35. The transmission device as claimed in claim 33, wherein it comprises means for making the two rotary elements rotate in opposite directions to one another.

36. The transmission device as claimed in claim 32, wherein the transmission path comprising the two elements comprises means for stepping up the rotational speed of each element.

37. The transmission device as claimed in claim 32, wherein one of the rotary elements is in a relationship for meshing at a fixed ratio with one of the input and output shafts, and the other rotary element is in a relationship for meshing at a fixed ratio with a rotary member of the differential mechanism, which rotary member is itself in a relationship for meshing at a variable ratio with each of the input and output shafts.

38. The transmission device as claimed in claim 32, wherein the at least one differential mechanism comprises two differential mechanisms each comprising three rotary members, in that the at least two transmission paths comprise three transmission paths each connecting a rotary member of one of the mechanisms to a respective rotary member of the other mechanism, wherein the two rotary elements form part of one of the three paths.

39. The device as claimed in claim 38, wherein one of the three paths is an input path comprising a transmission member secured to the input shaft, and another of the three paths is an output path comprising a transmission member secured to the output shaft, wherein one of the two rotary members connected by the third path tends to reduce the transmission ratio of its differential mechanism when its speed increases, and the other of the two rotary members tends to increase the transmission ratio of its differential mechanism when its speed increases.

40. The transmission device as claimed in claim 38, wherein the rotational speed applied to the apparatus by the two elements varies as a function of the speed of the input shaft, wherein the rotational speed applied to the apparatus increases when the speed of the input shaft increases.

41. The transmission device as claimed in claim 38, wherein two rotary members of one of the differential mechanisms are connected to the input shaft and to the output shaft respectively, so as to provide on its third rotary member a more or less mean of the speed of one of the input and output shafts and of the inverse of the speed of the other of the input and output shafts, and the third transmission path applies to the third member of the other differential mechanism a speed which is a function of said mean and which is in the opposite direction to the rotational speeds of the input shaft and of the output shaft.

42. The transmission device as claimed in claim 37, wherein two rotary members of one of the differential mechanisms are connected to the input shaft and to the output shaft respectively, so as to provide on its third rotary member a mean of the speed of the input shaft and of the speed of the output shaft, and the third transmission path applies to the third member of the other differential mechanism a speed which is a function of said mean.

43. The transmission device as claimed in claim 37, wherein the two differential mechanisms are identical and in that at least one of the three transmission paths defines, between the two rotary members that it connects, a transmission ratio that differs from that defined by another of the three paths between the two rotary members connected by this other path.

44. The transmission device as claimed in claim 37, wherein the differential mechanisms are identical and two of the three transmission paths define identical transmission ratios.

45. The transmission device as claimed in claim 44, wherein the three transmission paths define identical ratios and the two elements are connected to the apparatus differently.

46. The transmission device as claimed in claim 37, wherein the two differential mechanisms are of identical design and have a difference in tooth ratio, wherein preferably the three transmission paths define identical transmission ratios.

47. The transmission device as claimed in claim 40, wherein the two mechanisms are coaxial and at least one of the transmission paths is a connection that ensures common rotation of two rotary members belonging each to one of the mechanisms.

48. The transmission device as claimed in claim 32, wherein the differential mechanism is in the form of an epicyclic gearset comprising a sun gear connected to the output shaft, a ring gear consisting of a rotary reaction member, and a planet carrier connected to the input shaft and supporting at least one set of two planet pinions mounted in cascade, and of which one meshes with the sun gear and the other with the ring gear.

49. A unit for producing electricity comprising a transmission device as claimed in claim 32.

50. The unit for producing electricity as claimed in claim 49, further comprising a sensor that senses the rotational speed of the rotor of the electricity producing machine, and a control loop that regulates this rotational speed, which controls the apparatus as a function of the difference between the rotational speed of the rotor and a set point.

51. A wind turbine comprising a transmission device as claimed in claim 32.

52. A method for setting a transmission ratio between a motive power source and a load, wherein two differential mechanisms are placed between the motive power source and the load, these differential mechanisms each having at least three rotary members, each rotary member of one of the mechanisms being connected to a respective rotary member of the other mechanism by a respective transmission path, one of the paths comprising two rotary elements that are kinematically decoupled but connected by the action of a dynamic coupling apparatus, and the coupling apparatus is regulated, wherein the dynamic coupling apparatus has a shaft which is in a drive relationship with an output of a comparative differential gearset that has two inputs each consisting of one of the elements.
